(19) United States
(12) Patent Application Publication
(10) Pub. No.: US 2026/0012695 A1
(43) Pub. Date: Jan. 8, 2026

(54) FLUID SAMPLING DEVICE AND METHOD THEREOF

(71) Applicant: HONEYWELL INTERNATIONAL INC., Charlotte, NC (US)

(72) Inventor: Debendra Utkarsh, Charlotte, NC (US)

(21) Appl. No.: 19/252,763

(22) Filed: Jun. 27, 2025

(30) Foreign Application Priority Data
Jul. 4, 2024 (IN) 202411051250

(51) Int. Cl. H04N 23/56; G01N 1/30; G01N 21/01; G01N 21/25

(52) U.S. Cl. CPC H04N 23/56; G01N 1/30; G01N 21/01; G01N 21/255

(57) ABSTRACT

A fluid sampling device comprising a reel having a plurality of imaging chambers configured to receive a fluid sample. Each imaging chamber is configured to be illuminated from a first side and to emit light through the fluid sample and out of a second side. Further, the reel may comprise a plurality of fluid paths. Each fluid path of the plurality of fluid paths is positioned between two imaging chambers of the plurality of imaging chambers and at each end of an imaging chamber of the plurality of imaging chambers. Each fluid path is an interconnect between two imaging chambers to provide a flow path.

### CROSS-REFERENCE TO RELATED APPLICATION

This application claims priority pursuant to 35 U.S.C. 119(a) to Indian Patent Application No. 202411051250, filed Jul. 4, 2024, which application is incorporated herein by reference in its entirety.

### TECHNOLOGICAL FIELD

Example embodiments of the present disclosure relate generally to medical devices, and more particularly, to a fluid sampling device and method thereof.

### BACKGROUND

In the medical domain, various imaging techniques like flow cytometry, digital holography, ultraviolet (UV) microscopy etc., are used for cells imaging. Such techniques require containers for the cells to analyze, whether it's single slides, wells, or flow chambers. Identification of target analytes can be cells, tissues, pathogens, platelets, etc., especially in fluid media like blood, plasma, urine, and sweat, as well as in other fluid mediums like waste effluents from heavy metal industries. However, the imaging techniques, especially for iterative analysis of more than ten analytes, is cumbersome for end users, leading to high process variations in imaging of cells. Conventionally, for UV microscopy, multiple assays in slides with multiple wells are needed. There multiple assays further need high optical efficiency to identify the functional activity of analytes such as blood, plasma, urine, sweat, tissues, pathogens, or for DNA analysis. Managing logistics of these slides is a cumbersome process and requires huge expenditure.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a fluid sampling device is disclosed. The fluid sampling device comprises a reel having a plurality of imaging chambers configured to receive a fluid sample. Further, each imaging chamber is configured to be illuminated from a first side and to emit light through the fluid sample and out of a second side. Further, the reel is having a plurality of fluid paths. Each fluid path of the plurality of fluid paths is positioned between two imaging chambers of the plurality of imaging chambers and at each end of an imaging chamber of the plurality of imaging chambers. Further, each fluid path is an interconnect between two imaging chambers to provide a flow path.

In some embodiments, each imaging chamber of the plurality of imaging chambers is at least partially transparent to allow passing of the light emitted from an illumination source. Further, the light emitted by the illumination source corresponds to at least partially incoherent light.

In some embodiments, each fluid path is a flexible silicon tube configured to allow passage of the fluid sample across two of the imaging chambers of the plurality of imaging chambers. Further, the flexible silicon tube is configured to stain each imaging chamber of the plurality of imaging chambers.

In some embodiments, each imaging chamber of the plurality of imaging chambers includes an inlet port and an outlet port. Further, the inlet port is coupled with a first fluid path of the plurality of fluid paths and the outlet port is coupled with a second fluid path of the plurality of fluid paths. In some embodiments, the inlet port is configured to enable the first fluid path to inject the fluid sample within a corresponding imaging chamber of the plurality of imaging chambers and the outlet port is configured to enable the second fluid path to discharge the fluid sample from the corresponding imaging chamber of the plurality of imaging chambers.

In some embodiments, the fluid sampling device is configured for the fluid sample to be at least one of a peritoneal dialysis effluent, blood, urine, water contaminated with heavy metals, plasma, or oil. In some embodiments, the reel is configured to be continuously fed between the illumination source and an imaging unit.

In another example embodiment, a method is disclosed. The method comprising steps of providing a fluid sampling device comprising a reel having a plurality of imaging chambers configured to receive a fluid sample. Further, each imaging chamber is configured to be illuminated from a first side and to emit light through the fluid sample and out of a second side. Further, the reel is having a plurality of fluid paths. Each fluid path of the plurality of fluid paths is positioned between two imaging chambers of the plurality of imaging chambers and at each ends of an imaging chamber of the plurality of imaging chambers. Each fluid path is an interconnect between two imaging chambers to provide a flow path. Further, the method comprises steps of feeding the reel between an illumination source and an imaging unit. Thereafter, the method comprising the steps of capturing, with the imaging unit, one or more images of the fluid sample.

In yet another example embodiment, a fluid sampling system is disclosed. The fluid sampling system comprises a fluid sampling device of a reel having a plurality of imaging chambers configured to receive a fluid sample. Further, each imaging chamber is configured to be illuminated from a first side and to emit light through the fluid sample and out of a second side. Furth, the reel is having a plurality of fluid paths. Further, each fluid path of the plurality of fluid paths is positioned between two imaging chambers of the plurality of imaging chambers and at each end of an imaging chamber of the plurality of imaging chambers. Further, each fluid path is an interconnect between two imaging chambers to provide a flow path. Further, the fluid sampling system comprises an illumination source configured to illuminate the reel. Furthermore, the fluid sampling system comprises an imaging unit configured to capture one or more images of the fluid sample.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an isometric view of a fluid sampling system in accordance with an example embodiment of the present disclosure;

FIG. 2 illustrates a sectional view of the fluid sampling system incorporated with a fluid sampling device in accordance with an example embodiment of the present disclosure;

FIG. 3A illustrates a reel of the fluid sampling device in accordance with an example embodiment of the present disclosure;

FIG. 3B illustrates a side view of the reel of the fluid sampling device in accordance with an example embodiment of the present disclosure;

FIG. 4 illustrates a top sectional view of the fluid sampling system having the fluid sampling device positioned between an illumination source and an imaging unit in accordance with an example embodiment of the present disclosure;

FIG. 5 illustrates an imaging chamber of the reel illuminated from a first side and emitting light from a second side in accordance with an example embodiment of the present disclosure;

FIG. 6 illustrates one or more dimensions of the imaging chamber and a fluid path of the reel in accordance with an example embodiment of the present disclosure;

FIG. 7 illustrates a cam operated feeder for feeding the reel between the illumination source and the imaging unit in accordance with an example embodiment of the present disclosure;

FIG. 8 illustrates an architectural view of the fluid sampling system in accordance with an example embodiment of the present disclosure; and,

FIG. 9 illustrates a flowchart showing a method for the fluid sampling device in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a fluid sampling device. Embodiments may comprise a reel having a plurality of imaging chambers configured to receive a fluid sample. each imaging chamber is configured to be illuminated from a first side and to emit light through the fluid sample and out of a second side. Embodiments may comprise the reel having a plurality of fluid paths. Each fluid path of the plurality of fluid paths may be positioned between two imaging chambers of the plurality of imaging chambers. Each fluid path is an interconnect between two imaging chambers to provide a flow path.

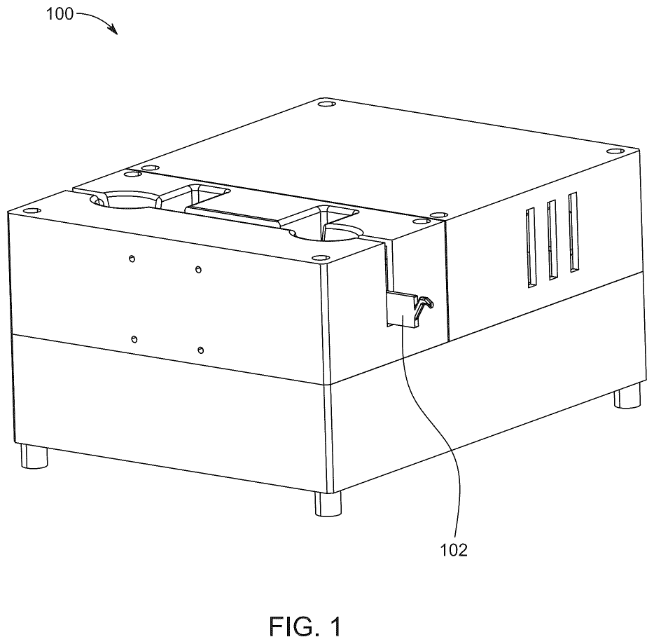

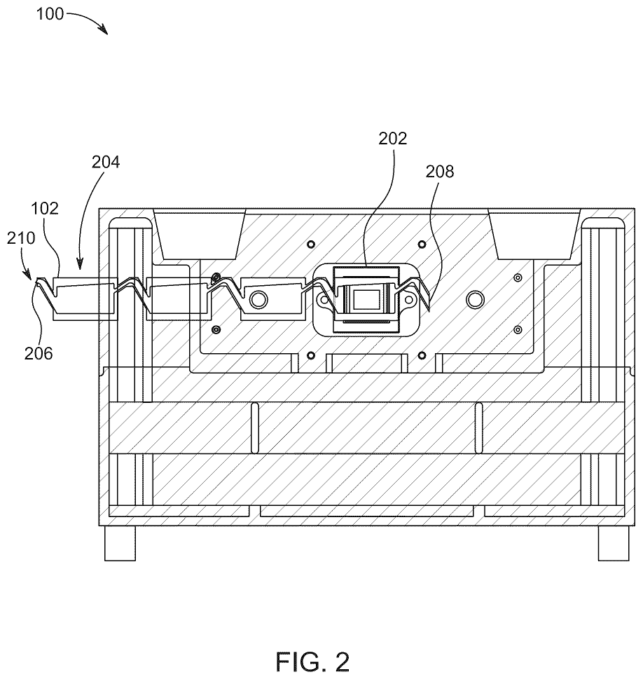

FIG. 1 illustrates an isometric view of a fluid sampling system 100 in accordance with an example embodiment of the present disclosure. FIG. 2 illustrates a sectional view of the fluid sampling system 100 in accordance with an example embodiment of the present disclosure.

The fluid sampling system 100 may comprise a fluid sampling device 102 of a reel (not shown), an illumination source (not shown), and an imaging unit 202, as illustrated in FIG. 2. In some embodiments, the fluid sampling system 100 may be configured to analyze a fluid sample. Further, the fluid sampling system 100 may comprise the illumination source and the imaging unit 202.

In some embodiments, the reel may comprise a plurality of imaging chambers 204 as shown in FIG. 2. The plurality of imaging chambers 204 may be configured to receive a fluid sample. The fluid sampling device 102 may be configured for the fluid sample to be at least one of a peritoneal dialysis effluent, blood, urine, water contaminated with heavy metals, plasma, or oil. Each imaging chamber from the plurality of imaging chambers 204 may be configured to be illuminated from a first side. Further, each imaging chamber from the plurality of chambers may be configured to emit light through the fluid sample and out of a second side. In some embodiments, each imaging chamber of the plurality of imaging chambers 204 is at least partially transparent to allow passing of the light emitted from the illumination source. The light emitted by the illumination source may correspond to at least partially incoherent light.

In some embodiments, the fluid sampling device 102 may include an inlet port 206 of the reel and an outlet port 208 of the reel, as illustrated by FIG. 2. In some embodiments, the reel may further comprise a plurality of fluid paths 210. Each fluid path of the plurality of fluid paths 210 may be positioned between two imaging chambers of the plurality of imaging chambers 204 and at each end of an imaging chamber of the plurality of imaging chambers 204. Each fluid path may be an interconnect between two imaging chambers to provide a flow path. In some embodiments, each fluid path may be a flexible silicon tube. The flexible silicon tube may be configured to allow passage of the fluid sample across two of the imaging chambers of the plurality of imaging chambers 204. The flexible silicon tube may be configured to stain each imaging chamber of the plurality of imaging chambers 204.

In some embodiments, the inlet port is coupled with a first fluid path of the plurality of fluid paths 210 and the outlet port is coupled with a second fluid path of the plurality of fluid paths 210. The inlet port is configured to enable the first fluid path to inject the fluid sample within a corresponding imaging chamber of the plurality of imaging chambers 204 and the outlet port is configured to enable the second fluid path to discharge the fluid sample from the corresponding imaging chamber of the plurality of imaging chambers 204.

In some embodiments, the illumination source may be positioned at a first side of the fluid sampling device 102. The illumination source may be configured to illuminate the plurality of imaging chambers 204. The illumination source may be configured to emit light through the fluid sample contained within at least one imaging chamber of the plurality of imaging chambers 204. In some embodiments, each imaging chamber of the plurality of imaging chambers 204 may be at least partially transparent to allow passing of the light emitted from the illumination source. Furthermore, the imaging unit 202 may be positioned at a second side of the fluid sampling device 102. The imaging unit 202 may be configured to receive the light from the at least one imaging chamber of the plurality of imaging chambers 204. Further, the imaging unit 202 may be configured to capture one or more images of the fluid sample. In some embodiments, the reel may be configured to be continuously fed between the illumination source and the imaging unit be continuously fed between the illumination source and the imaging unit 202.

In some embodiments, the fluid sampling system 100 may comprise at least one processing unit and a non-transitory memory comprising one or more instructions. The non-transitory memory along with the one or more instructions may cause the at least one processing unit to analyze the one or more images captured. The one or more images may be analyzed to estimate at least one characteristics of particles within the fluid sample. The non-transitory memory along with the one or more instructions may cause the at least one processing unit to use one or more techniques. The one or more techniques may be used to estimate the at least one characteristics of the particles within the fluid sample using an artificial intelligence (AI) protocol. In one example embodiment, the one or more techniques may comprise at least one of a microscopy technique, or flow cytometry technique.

In some embodiments, the non-transitory memory having the one or more instructions along with the at least one processing unit may correspond to a remote computing platform. The remote computing platform may be communicatively coupled to the imaging unit 202. Further, the remote computing platform may receive the one or more images of the fluid sample. The remote computing platform may receive the one or more images via a communication module. The communication module may correspond to Wi-Fi adapters, Bluetooth transceivers, Ethernet ports, cellular modems, Zigbee modules, and NFC (Near Field Communication) receivers that integrated into the remote computing platform. In one example embodiment, the at least one characteristics of the particles within the fluid sample may include estimated concentration of leukocytes, red blood cells (RBCs), and estimated size of the particles.

The at least one processing unit may include suitable logic, circuitry, and/or interfaces that are operable to execute one or more instructions stored in the non-transitory memory to perform predetermined operations. In one embodiment, the at least one processing unit may be configured to decode and execute any instructions received from one or more other electronic devices or server(s). The at least one processing unit may be configured to execute one or more computer-readable program instructions, such as program instructions to carry out any of the functions described in this description. Examples of the at least one processing unit include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the non-transitory memory may be configured to store a set of instructions, or the one or more instructions, and data executed by the at least one processing unit. Further, the non-transitory memory may include the one or more instructions that are executable by the at least one processing unit to perform specific operations. The non-transitory memory may be configured to include the instructions to analyze the one or more images captured to estimate at least one characteristics of the particles within the fluid sample. It is apparent to a person with ordinary skill in the art that the one or more instructions stored in the non-transitory memory enable the hardware of the at least one processing unit to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

It will be apparent to one skilled in the art the above-mentioned components of the fluid sampling system 100 and the fluid sampling device 102 have been provided only for illustration purposes, without departing from the scope of the disclosure.

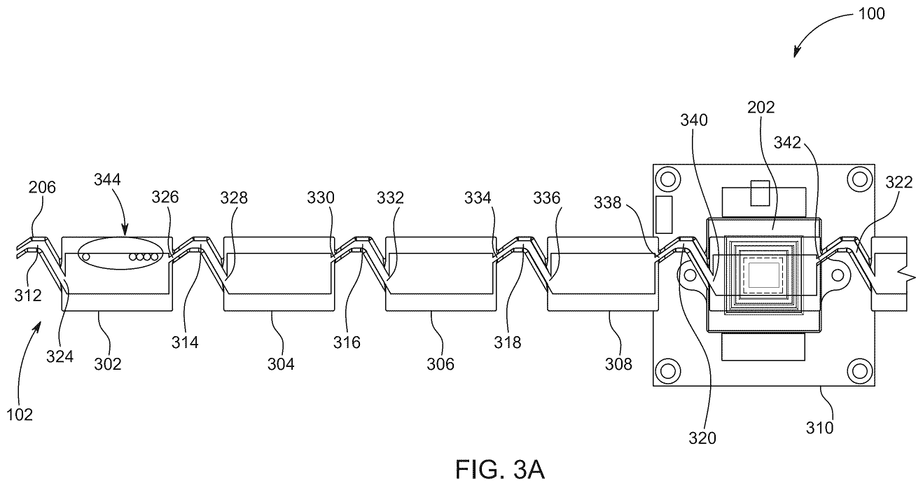

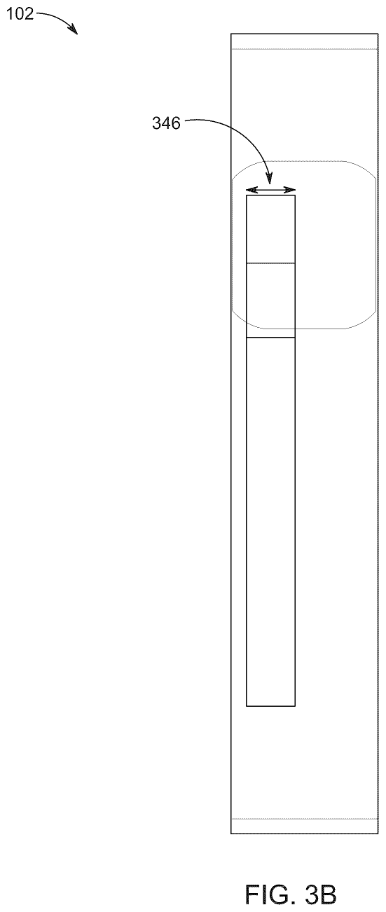

FIG. 3A illustrates the reel of the fluid sampling device 102 in accordance with an example embodiment of the present disclosure. FIG. 3B illustrates a side view of the reel of the fluid sampling device 102 in accordance with an example embodiment of the present disclosure.

As described above in FIG. 2, the reel may comprise the plurality of imaging chambers 204. The plurality of imaging chambers 204 may be configured to receive the fluid sample. In some embodiments, the plurality of imaging chambers 204 may comprise a first imaging chamber 302, a second imaging chamber 304, a third imaging chamber 306, a fourth imaging chamber 308, and a fifth imaging chamber 310, as illustrated in FIG. 3A. The first imaging chamber 302, the second imaging chamber 304, the third imaging chamber 306, the fourth imaging chamber 308, and the fifth imaging chamber 310 may be at least partially transparent in nature to allow passing of the light emitted from the illumination source.

Further, the reel may comprise the plurality of fluid paths 210. Each fluid path of the plurality of fluid paths 210 may be positioned between two imaging chambers of the plurality of imaging chambers 204 to interconnect each of the plurality of imaging chambers 204. In one example embodiment, a first fluid path 312 may be positioned at beginning of the first imaging chamber 302 to enable injection of the fluid sample inside the reel from the inlet port 206 of the reel. In another example embodiment, a second fluid path 314 may be positioned between the first imaging chamber 302 and the second imaging chamber 304 to interconnect the first imaging chamber 302 and the second imaging chamber 304. In yet another example embodiment, a third fluid path 316 may be positioned between the second imaging chamber 304 and the third imaging chamber 306 to interconnect the second imaging chamber 304 and the third imaging chamber 306.

In another example embodiment, a fourth fluid path 318 may be positioned between the third imaging chamber 306 and the fourth imaging chamber 308 to interconnect the third imaging chamber 306 and the fourth imaging chamber 308. In yet another example embodiment, a fifth fluid path 320 may be positioned between the fourth imaging chamber 308 and the fifth imaging chamber 310 to interconnect the fourth imaging chamber 308 and the fifth imaging chamber 310. In another example embodiment, a sixth fluid path 322 may be positioned at end of the fifth imaging chamber 310 to discharge the fluid sample from the reel.

In some embodiments, each of the first fluid path 312, the second fluid path 314, the third fluid path 316, the fourth fluid path 318, the fifth fluid path 320, and the sixth fluid path 322 may be the flexible silicon tube. The flexible silicon tube may be configured to allow passage of the fluid sample across the plurality of imaging chambers 204 of the reel. The flexible silicon tube may be configured to stain the first imaging chamber 302, the second imaging chamber 304, the third imaging chamber 306, the fourth imaging chamber 308, and the fifth imaging chamber 310 of the plurality of imaging chambers 204.

In one example embodiment, the first imaging chamber 302 may comprise a first inlet port 324 and a first outlet port 326. In some embodiments, the inlet port 206 of the reel may act as inlet port for entering the fluid sample within the first fluid path 312. The first inlet port 324 may be coupled with the first fluid path 312 of the plurality of fluid paths 210. The first outlet port 326 may be coupled with the second fluid path 314 of the plurality of fluid paths 210. The first inlet port 324 may be configured to enable the first fluid path 312 to inject the fluid sample within the first imaging chamber 302 from the inlet port 206 of the reel. Further, the first outlet port 326 may be configured to enable the second fluid path 314 to discharge the fluid sample from the first imaging chamber 302 of the plurality of imaging chambers 204.

In another example embodiment, the second imaging chamber 304 may comprise a second inlet port 328 and a second outlet port 330. The second inlet port 328 may be coupled with the second fluid path 314. The second outlet port 330 may be coupled with the third fluid path 316. The second inlet port 328 may be configured to enable the second fluid path 314 to inject the fluid sample within the second imaging chamber 304 from the first imaging chamber 302. Further, the second outlet port 330 may be configured to enable the third fluid path 316 to discharge the fluid sample from the second imaging chamber 304.

In yet another example embodiment, the third imaging chamber 306 may comprise a third inlet port 332 and a third outlet port 334. The third inlet port 332 may be coupled with the third fluid path 316. The third outlet port 334 may be coupled with the fourth fluid path 318. The third inlet port 332 may be configured to enable the third fluid path 316 to inject the fluid sample within the third imaging chamber 306 from the second imaging chamber 304. Further, the third outlet port 334 may be configured to enable the fourth fluid path 318 to discharge the fluid sample from the third imaging chamber 306.

In another example embodiment, the fourth imaging chamber 308 may comprise a fourth inlet port 336 and a fourth outlet port 338. The fourth inlet port 336 may be coupled with the fourth fluid path 318. The fourth outlet port 338 may be coupled with the fifth fluid path 320. The fourth inlet port 336 may be configured to enable the fourth fluid path 318 to inject the fluid sample within the fourth imaging chamber 308 from the third imaging chamber 306. Further, the fourth outlet port 338 may be configured to enable the fifth fluid path 320 to discharge the fluid sample from the fourth imaging chamber 308.

In yet another example embodiment, the fifth imaging chamber 310 may comprise a fifth inlet port 340 and a fifth outlet port 342. The fifth inlet port 340 may be coupled with the fifth fluid path 320. The fifth outlet port 342 may be coupled with the sixth fluid path 322. The fifth inlet port 340 may be configured to enable the fifth fluid path 320 to inject the fluid sample within the fifth imaging chamber 310 from the fourth imaging chamber 308. Further, the fifth outlet port 342 may be configured to enable the sixth fluid path 322 to discharge the fluid sample from the fifth imaging chamber to another imaging chamber of the plurality of imaging chambers.

In some embodiments, the reel may entrap the fluid sample in the form of one or more bubbles, as illustrated by 344 in FIG. 3A. The reel may entrap the fluid sample when the fluid sample may be injected within the first imaging chamber 302 of the plurality of imaging chambers 204. In some embodiments, the reel may define a depth for the fluid sample after the entrapment of the fluid sample. In one example embodiment, the depth for the fluid sample may correspond to a range between 0.2 mm to 2 mm, as illustrated by 346 in FIG. 3B.

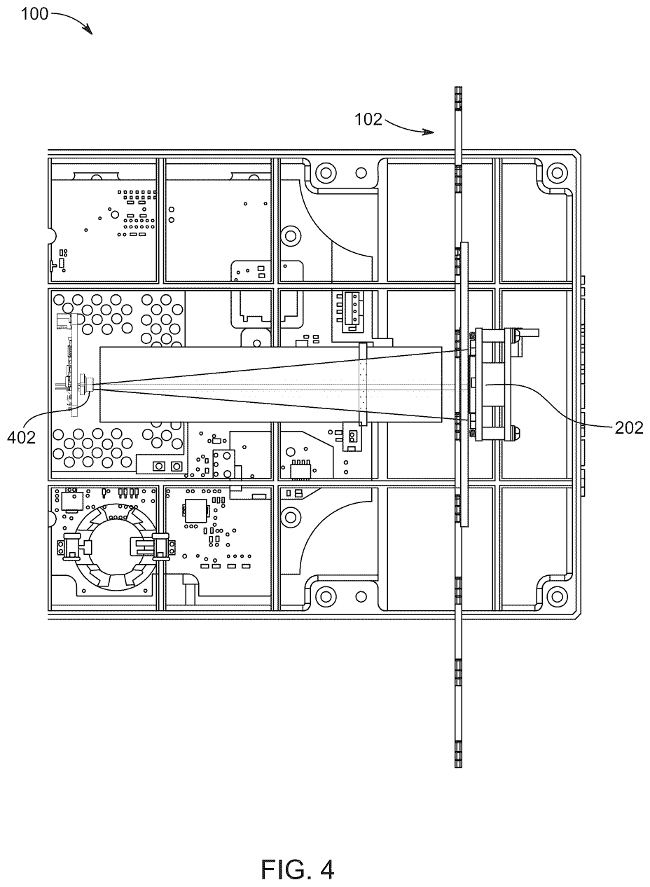

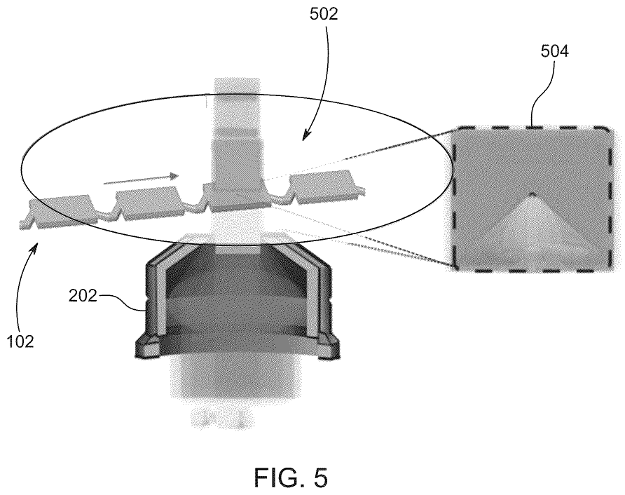

FIG. 4 illustrates a top sectional view of the fluid sampling system 100 having the fluid sampling device 102 positioned between an illumination source 402 and the imaging unit 202 in accordance with an example embodiment of the present disclosure. FIG. 5 illustrates an imaging chamber of the reel illuminated from a first side and emitting light from a second side in accordance with an example embodiment of the present disclosure.

As described above in FIG. 1, the fluid sampling system 100 may comprise the reel of the fluid sampling device 100, the illumination source 402, and the imaging unit 202. Further, the reel may comprise the plurality of imaging chambers 204 to receive the fluid sample. The reel may comprise the plurality of fluid paths 210. Each fluid path of the plurality of fluid paths 210 may be positioned between two imaging chambers of the plurality of imaging chambers 204. Further, the fluid sampling device 102 may include the inlet port 206 of the reel and the outlet port 208 of the reel. Each of the fluid path may correspond to the flexible silicon tube configured to allow passage of the fluid sample across the plurality of imaging chambers 204.

In some embodiments, the illumination source 402 may be positioned at the first side of the fluid sampling device 102. The illumination source 402 may be configured to emit light through the fluid sample contained within at least one imaging chamber of the plurality of imaging chambers 204. In some embodiments, each imaging chamber of the plurality of imaging chambers 204 may be at least partially transparent in nature to allow passing of the light emitted from the illumination source 402. In one example embodiment, the light emitted by the illumination source 402 may correspond to at least partially incoherent light. The at least partially incoherent light may reduce interference patterns and enhances contrast in the one or more images captured by the imaging unit 202. The reduced interference patterns and enhanced contrast may lead to clearer and more detailed analysis of the fluid sample within the plurality of imaging chambers 204. In another example embodiment, the light may correspond to a laser, a helium-neon (He—Ne) laser, ultraviolet (UV) laser, near-infrared (NIR) laser, or any other light known in the art.

Furthermore, the imaging unit 202 may be positioned at the second side of the fluid sampling device 102. The imaging unit 202 may be configured to receive the light from the illumination source 402 and capture one or more images of the fluid sample, as illustrated by 502 in FIG. 5. The imaging unit 202 may be configured to capture one or more images of the fluid sample on an imaging plane 504. Further, the imaging unit 202 may have a numerical aperture (N.A.) of at least 1.4. The N.A. of 1.4 may indicate that the imaging unit 202 may have a high capacity to collect the light emitted from the illumination source 402. Further, the N.A. of 1.4 may indicate that the imaging unit 202 may resolve fine details, leading to high-resolution one or more images with excellent clarity and contrast.

In some embodiments, each of the plurality of imaging chambers 204 of the reel may be continuously fed between the illumination source 402 and the imaging unit 202. Further, a feeder may be employed to continuously fed each of the plurality of imaging chambers 204 of the reel between the illumination source 402 and the imaging unit 202. In one example embodiment, the first side and the second side may be opposite to each other. The feeder may correspond to at least one of a step feeder, a pick and place feeder, and a cam operated feeder. In one example embodiment, the step feeder may comprise a plurality of steps, a motor and a holding member for feeding each of the plurality of imaging chambers 204 consecutively. In another example embodiment, the pick and place feeder may comprise a robotic arm for feeding each of the plurality of imaging chambers 204 consecutively. In yet another example embodiment, the cam operated feeder may comprise a plurality of rotating cams each for feeding each of the plurality of imaging chambers 204 consecutively. In some embodiments, the imaging unit 202 may be configured to use one or more techniques. The one or more techniques may comprise at least one of a digital holography technique, or an optical microscopy technique to capture the one or more images of the fluid sample. Further, the one or more techniques may use UV fluorescence.

In some embodiments, the fluid sampling device 102 may comprise at least one processing unit and a non-transitory memory comprising the computer code that causes the at least one processing unit to analyze the one or more images captured. The one or more images may be analyzed to estimate at least one characteristics of particles within the fluid sample. In one example embodiment, the at least one characteristics of the particles within the fluid sample may include estimated concentration of leukocytes, red blood cells (RBCs), and estimated size of the particles. The non-transitory memory along with the computer program code may cause the at least one processing unit to use one or more techniques. The one or more techniques may be used to estimate the at least one characteristics of the particles within the fluid sample using an artificial intelligence (AI) protocol. In one example embodiment, the one or more techniques may comprise at least one of a microscopy technique, or flow cytometry technique. In one example embodiment, the microscopy technique may utilize optical or electron microscopy to visualize and analyze particles within the fluid sample at a microscopic level to providing detailed information about the size, shape, and distribution of the particles. In another example embodiment, the flow cytometry technique may involve the detection and analysis of particles within the fluid sample as the particles pass through a laser beam to allow for rapid quantification and characterization of individual particles based on the optical and fluorescent properties.

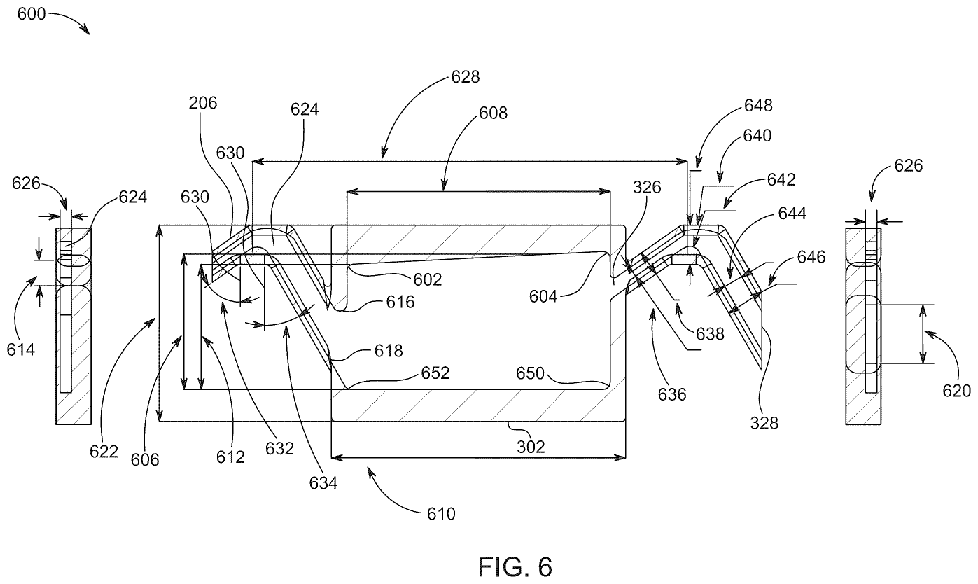

FIG. 6 illustrates one or more dimensions of the imaging chamber and a fluid path of the reel in accordance with an example embodiment of the present disclosure.

In some embodiments, a portion 600 of the reel may be illustrated. The portion 600 may comprise the first imaging chamber 302 having a first end 602, a second end 604, a third end 650, and a fourth end 652. A height of the first imaging chamber 302 between the second end 604 and the third end 650 may be defined as 7 mm, as illustrated by 606. Further, a width of the first imaging chamber 302 from the first end 602 till the second end 604, having the fluid path may be defined by 13.4 mm, as illustrated by 608. Furthermore, a total width of the first imaging chamber 302 may be defined as 15 mm, as illustrated by 610. The first imaging chamber 302 may include a slope between the first end 602 and the second end 604. The slope may be defined as 3°, as illustrated by 612. The slope may define a width of 0.9 mm, as illustrated by 614. Further, the first imaging chamber may comprise a first point 616 and a second point 618. A distance may be defined between the first point 616 and the second point 618. The distance may be defined as 3 mm, as illustrated by 620. In some embodiments, a height of the reel may be defined by a length of 10 mm, as illustrated by 622. In some embodiments, the portion 600 may comprise a fluid path 624. The fluid path 624 may be defined from a depth of 0.6 mm, as illustrated by 626.

In some embodiments, the first imaging chamber 302 may comprise the first outlet port 326. Further, a width of the portion 600 comprising the first imaging chamber 302 may be defined by a width of 22 mm, as illustrated by 628. The first outlet port 326 may correspond to the flexible silicon tube. The inlet port 206 may comprise a first tube angle with respect to a portion of the inlet port 206 and the y-axis 630. The first tube angle may be defined as 55°, as illustrated by 632. The inlet port 206 may comprise a second tube angle with respect to a portion of the inlet port 206 and the y-axis 630. The second tube angle may be defined as 30°, as illustrated by 634. Further, the first outlet port 326 may be defined a diameter of 0.3 mm inside the fluid path 624, as illustrated by 636. And, the first outlet port 326 may be defined a diameter of 1.3 mm outside the fluid path 624, as illustrated by 638.

In an instance in which the first outlet port 326 connects with the second inlet port 328, an outer curvature may exist that may be defined by a radius “R2”, as illustrated in FIG. 640. Further, an inner curvature may exist that may be defined by a radius “R0.7”, as illustrated in FIG. 642. Further, the second inlet port 328 may be defined a diameter of 1 mm from inside, as illustrated by 644. And, the second inlet port 328 may be defined a diameter of 2 mm from outside, as illustrated by 646. Further, an outer boundary of the inlet port 206, the first outlet port 326, and the second inlet port 328 may be defined by a thickness of 2 mm, as illustrated by 648.

In some embodiments, the inlet port 206, the first inlet port 324 the first outlet port 326, the second inlet port 328, the second outlet port 330, the third inlet port 332, the third outlet port 334, the fourth inlet port 336, the fourth outlet port 338, the fifth inlet port 340, and the fifth outlet port 342 with the first imaging chamber 302, the second imaging chamber 304, the third imaging chamber 306, the fourth imaging chamber 308, and the fifth imaging chamber 310 may comprise the same one or more dimensions as described above.

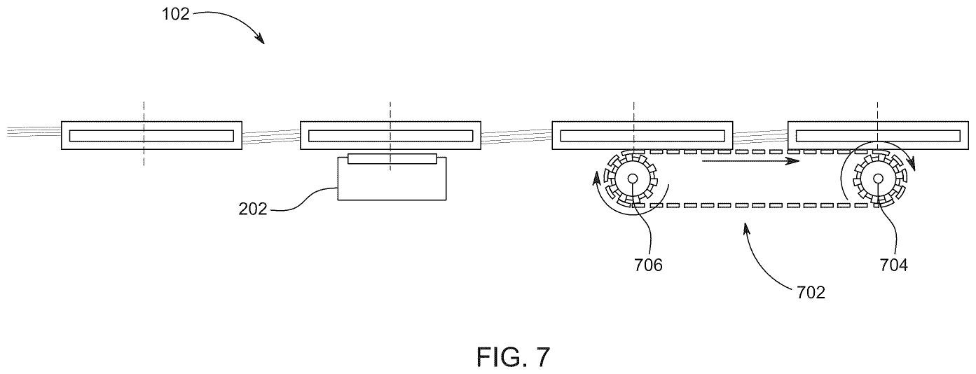

FIG. 7 illustrates the cam operated feeder for feeding the reel between the illumination source 402 and the imaging unit 202 in accordance with an example embodiment of the present disclosure.

As described above in FIG. 4, each of the plurality of imaging chambers 204 may be fed consecutively via using the feeder. In one example embodiment, the feeder may correspond to the cam operated feeder, as illustrated by 702. The cam operated feeder may be suited in an instance in which a specific motion or timing is required in the fluid sampling device 102. In some embodiments, the cam operated feeder may comprise the plurality of rotating cams each for feeding each of the plurality of imaging chambers 204 consecutively.

In some embodiments, the plurality of rotating cams may comprise a first rotating cam 704 and a second rotating cam 706. The first rotating cam 704 and the second rotating cam 706 may work in tandem to ensure the smooth and accurate movement of each imaging chamber, allowing for precise positioning and analysis of the fluid sample contained within each imaging chamber. The first rotating cam 704 and the second rotating cam 706 may synchronize the rotations to sequentially advance each imaging chamber through the fluid sampling device 102. As the first rotating cam 704 may complete one rotation cycle, the first rotating cam 704 advances each imaging chamber to the next stage. Further, the second rotating cam 706 may initiate the rotation, advancing each imaging chamber, and so forth. By working in tandem, first rotating cam 704 and the second rotating cam 706 may maintain proper timing and positioning, facilitating the smooth operation of the feeder and ensuring accurate results in the fluid sampling device 102.

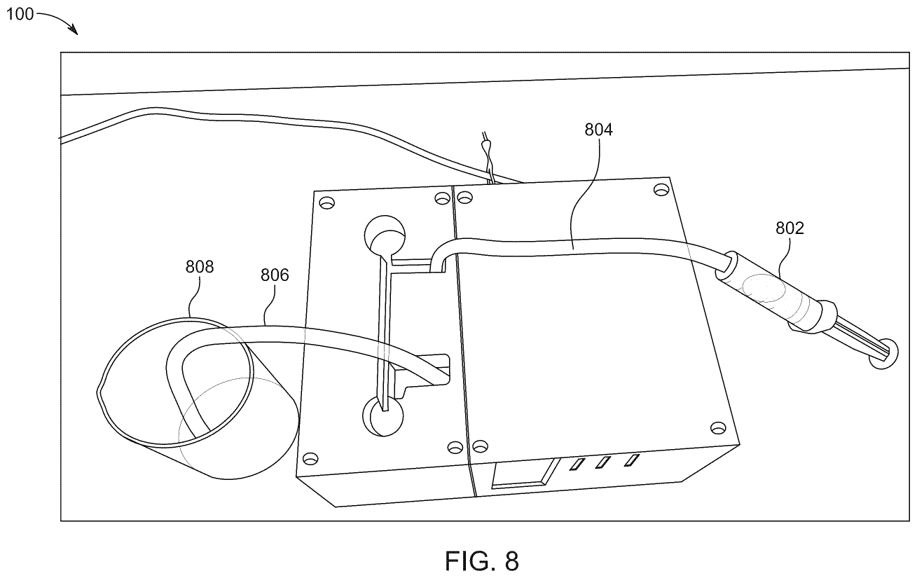

FIG. 8 illustrates an architectural view of the fluid sampling system 100 in accordance with an example embodiment of the present disclosure.

In one example embodiment, the fluid sampling device 102 may receive the fluid sample from an injecting device 802. The injecting device 802 may correspond to a syringe. The injecting device 802 may inject the fluid sample in the inlet port 206, via a first tube 804. Further, the plurality of imaging chambers 204 may receive the fluid sample via the tube 804. Furthermore, the illumination source 402 may emit light through the fluid sample contained within at least one imaging chamber of the plurality of imaging chambers 204. Further, the imaging unit 202 may receive the light from the illumination source 402 and capture one or more images of the fluid sample. Furthermore, the non-transitory memory along with the computer program code may cause the at least one processing unit to analyze the one or more images captured to estimate at least one characteristics of particles within the fluid sample. Thereafter, the outlet port 208 may discharge the fluid sample outside the reel, via a second tube 806. The first tube 804 and the second tube 806 may correspond to a plastic tube or a glass tube. The fluid sample may be discharge in a beaker 808, via the second tube 806.

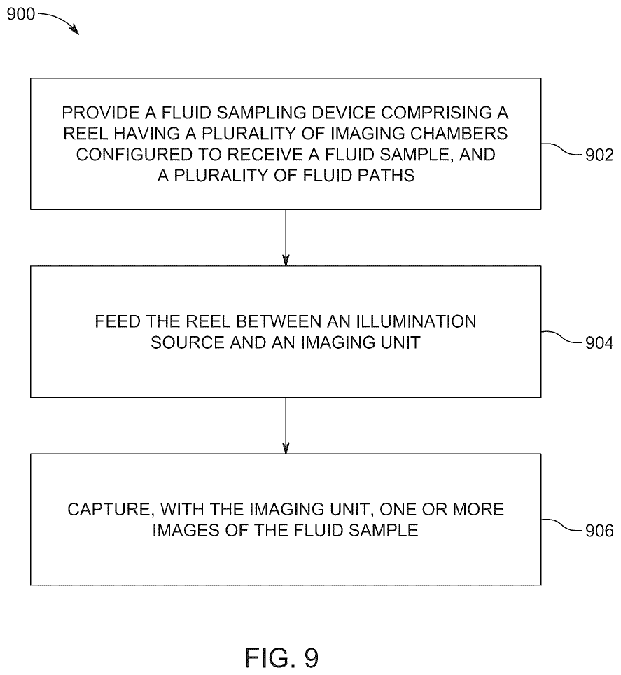

FIG. 9 illustrates a flowchart showing a method 900 for the fluid sampling device 102 in accordance with an example embodiment of the present disclosure.

At operation 902, the fluid sampling device 102 comprising the reel may be provided. The reel may have the plurality of imaging chambers 204 configured to receive the fluid sample. The fluid sampling device may be configured for the fluid sample to be at least one of the peritoneal dialysis effluent, blood, urine, water contaminated with heavy metals, plasma, or oil. Each imaging chamber may be configured to be illuminated from the first side and to emit light through the fluid sample and out of the second side. Further, the reel may have the plurality of fluid paths 210. Each fluid path of the plurality of fluid paths 210 may be positioned between two imaging chambers of the plurality of imaging chambers 204 and at each ends of the imaging chamber of the plurality of imaging chambers 204. Further, each fluid path may be an interconnect between two imaging chambers to provide the flow path.

In some embodiments, each fluid path may be the flexible silicon tube configured to allow passage of the fluid sample across two of the imaging chambers of the plurality of imaging chambers 204. The flexible silicon tube may be configured to stain each imaging chamber of the plurality of imaging chambers 204. The fluid sampling device 102 may comprise the inlet port 206 of the reel and the outlet port 208 of the reel. In some embodiments, each imaging chamber of the plurality of imaging chambers 204 may include an inlet port and an outlet port. In one example, the inlet port may be inlet port of the first imaging chamber 302, the second imaging chamber 304, the third imaging chamber 306, the fourth imaging chamber 308, or the fifth imaging chamber 310, as described in FIG. 3A. In another example, the outlet port may be outlet ports of the first imaging chamber 302, the second imaging chamber 304, the third imaging chamber 306, the fourth imaging chamber 308, or the fifth imaging chamber 310, as described in FIG. 3B. In one example embodiment, the first inlet port 324 may be coupled with the first fluid path 312 of the plurality of fluid paths 210. The first outlet port 326 may be coupled with the second fluid path 314 of the plurality of fluid paths 210.

For example, the fluid sampling device 102 for analyzing a fluid sample such as blood or urine is provided, and includes the reel that receives the fluid sample in the plurality of imaging chambers 204. Further, each of the fluid paths is positioned between two imaging chambers of the plurality of imaging chambers 204 to interconnect each of the plurality of imaging chambers 204. Each fluid path allows the fluid sample to pass through and stain each imaging chamber for analysis.

At operation 904, the reel may be feed between the illumination source 402 and the imaging unit 202. In some embodiments, each imaging chamber of the plurality of imaging chambers 204 may be at least partially transparent to allow passing of the light emitted from the illumination source 402. The light emitted by the illumination source 402 may correspond to the at least partially incoherent light. In some embodiments, feeding the reel between the illumination source 402 and the imaging unit 202 may comprise continuously feeding the reel. In one example embodiment, the first imaging chamber 302 of the reel may be illuminated with the illumination source 402.

For example, the illumination source 402 is located on the first side of the fluid sampling device 102, directing light through each imaging chamber that is partially transparent, enabling the light from the illumination source 402 to pass through. The emitted light, in this case, is at least partially incoherent light, aiding in the analysis of the fluid sample within the imaging chamber of the fluid sampling device 102. A feeder, such as the cam operated feeder, transports the plurality of imaging chambers 204 between the illumination source 402 and the imaging unit 202.

At operation 906, the imaging unit 202 may capture the one or more images of the fluid sample. In one example embodiment, capturing the one or more images of the fluid sample may include capturing the one or more images of the fluid sample in the first imaging chamber 302 illuminated by the illumination source 402. For example, the imaging unit 202 positioned at the second side of the fluid sampling device 102 captures one or more images of the fluid sample, utilizing light from the illumination source 402. The imaging unit 202 uses the optical microscopy technique, including UV fluorescence, for capturing of the one or more images. Further, the at least one processing unit and the non-transitory memory comprising the computer code analyzes the captured one or more images to estimate characteristics of particles in the fluid sample. Using AI protocol, a microscopy technique is employed for analysis. Characteristics analyzed includes estimated concentrations of leukocytes, RBCs, and particle sizes.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A fluid sampling device comprising:
a reel having:
a plurality of imaging chambers configured to receive a fluid sample, wherein each imaging chamber is configured to be illuminated from a first side and to emit light through the fluid sample and out of a second side; and
a plurality of fluid paths, wherein each fluid path of the plurality of fluid paths is positioned between two imaging chambers of the plurality of imaging chambers and at each end of an imaging chamber of the plurality of imaging chambers, and wherein each fluid path is an interconnect between two imaging chambers to provide a flow path.

2. The fluid sampling device of claim 1, wherein each imaging chamber of the plurality of imaging chambers is at least partially transparent to allow passing of the light emitted from an illumination source, wherein the light emitted by the illumination source corresponds to at least partially incoherent light.

3. The fluid sampling device of claim 1, wherein each fluid path is a flexible silicon tube configured to allow passage of the fluid sample across two of the imaging chambers of the plurality of imaging chambers, wherein the flexible silicon tube is configured to stain each imaging chamber of the plurality of imaging chambers.

4. The fluid sampling device of claim 1, wherein each imaging chamber of the plurality of imaging chambers includes an inlet port and an outlet port, wherein the inlet port is coupled with a first fluid path of the plurality of fluid paths and the outlet port is coupled with a second fluid path of the plurality of fluid paths.

5. The fluid sampling device of claim 4, wherein the inlet port is configured to enable the first fluid path to inject the fluid sample within a corresponding imaging chamber of the plurality of imaging chambers and the outlet port is configured to enable the second fluid path to discharge the fluid sample from the corresponding imaging chamber of the plurality of imaging chambers.

6. The fluid sampling device of claim 1, wherein the fluid sampling device is configured for the fluid sample to be at least one of a peritoneal dialysis effluent, blood, urine, water contaminated with heavy metals, plasma, or oil.

7. The fluid sampling device of claim 2, wherein the reel is configured to be continuously fed between the illumination source and an imaging unit.

8. A method comprising:
providing a fluid sampling device comprising a reel having:
a plurality of imaging chambers configured to receive a fluid sample, wherein each imaging chamber is configured to be illuminated from a first side and to emit light through the fluid sample and out of a second side; and
a plurality of fluid paths, wherein each fluid path of the plurality of fluid paths is positioned between two imaging chambers of the plurality of imaging chambers and at each ends of an imaging chamber of the plurality of imaging chambers, and wherein each fluid path is an interconnect between two imaging chambers to provide a flow path;
feeding the reel between an illumination source and an imaging unit; and
capturing, with the imaging unit, one or more images of the fluid sample.

9. The method of claim 8, wherein each imaging chamber of the plurality of imaging chambers is at least partially transparent to allow passing of the light emitted from an illumination source, wherein the light emitted by the illumination source corresponds to at least partially incoherent light.

10. The method of claim 8, wherein each fluid path is a flexible silicon tube configured to allow passage of the fluid sample across two of the imaging chambers of the plurality of imaging chambers, wherein the flexible silicon tube is configured to stain each imaging chamber of the plurality of imaging chambers.

11. The method of claim 8, wherein each imaging chamber of the plurality of imaging chambers includes an inlet port and an outlet port, wherein the inlet port is coupled with a first fluid path of the plurality of fluid paths and the outlet port is coupled with a second fluid path of the plurality of fluid paths.

12. The method of claim 8, wherein the fluid sampling device is configured for the fluid sample to be at least one of a peritoneal dialysis effluent, blood, urine, water contaminated with heavy metals, plasma, or oil.

13. The method of claim 8, wherein feeding the reel between the illumination source and the imaging unit comprises continuously feeding the reel.

14. The method of claim 8 further comprising:
illuminating a first imaging chamber of the reel with the illumination source; and
wherein capturing one or more images of the fluid sample includes capturing one or more images of the fluid sample in the first imaging chamber illuminated by the illumination source.

15. A fluid sampling system comprising:
a fluid sampling device of a reel having:
a plurality of imaging chambers configured to receive a fluid sample, wherein each imaging chamber is configured to be illuminated from a first side and to emit light through the fluid sample and out of a second side; and
a plurality of fluid paths, wherein each fluid path of the plurality of fluid paths is positioned between two imaging chambers of the plurality of imaging chambers and at each ends of an imaging chamber of the plurality of imaging chambers, and wherein each fluid path is an interconnect between two imaging chambers to provide a flow path;
an illumination source configured to illuminate the reel; and,
an imaging unit configured to capture one or more images of the fluid sample.

16. The fluid sampling system of claim 15, wherein each imaging chamber of the plurality of imaging chambers is at least partially transparent to allow passing of the light emitted from the illumination source, wherein the light emitted by the illumination source corresponds to at least partially incoherent light.

17. The fluid sampling system of claim 15, wherein each fluid path is a flexible silicon tube configured to allow passage of the fluid sample across two of the imaging chambers of the plurality of imaging chambers, wherein the flexible silicon tube is configured to stain each imaging chamber of the plurality of imaging chambers.

18. The fluid sampling system of claim 15, wherein each imaging chamber of the plurality of imaging chambers includes an inlet port and an outlet port, wherein the inlet port is coupled with a first fluid path of the plurality of fluid paths and the outlet port is coupled with a second fluid path of the plurality of fluid paths.

19. The fluid sampling system of claim 15, wherein the fluid sampling device is configured for the fluid sample to be at least one of a peritoneal dialysis effluent, blood, urine, water contaminated with heavy metals, plasma, or oil.

20. The fluid sampling system of claim 15, wherein the reel is configured to be continuously fed between the illumination source and the imaging unit.
